(19) United States
(12) Patent Application Publication
(10) Pub. No.: US 2021/0095147 A1
(43) Pub. Date: Apr. 1, 2021

(54) CYAN PIGMENT DISPERSION

(71) Applicant: Hewlett-Packard Development Company, L.P., Spring, TX (US)

(72) Inventors: Jie Zheng, San Diego, CA (US); Dennis Z. Guo, San Diego, CA (US)

(21) Appl. No.: 17/050,767

(22) PCT Filed: Jun. 11, 2018
(86) PCT No.: PCT/US18/36890

§ 371 Date: Oct. 26, 2020

(51) Int. Cl. C09D 11/322; C09D 17/00; C09D 11/037; C09D 11/023; B41J 2/21; B41M 5/00

(52) U.S. Cl. CPC C09D 11/322; C09D 17/003; C09D 17/001; B41M 5/0023; C09D 11/023; B41J 2/2107; C09D 11/037

(57) ABSTRACT

A cyan pigment dispersion includes a non-self-dispersed cyan pigment, a first dispersant, a second dispersant, and a balance of water. The first dispersant is a styrene-acrylic copolymer having an acid number ranging from about 120 mg KOH/g to about 220 mg KOH/g. The second dispersant has an acid number less than 100 mg KOH/g.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Some commercial and industrial inkjet printers utilize fixed printheads and a moving substrate web in order to achieve high speed printing. Current inkjet printing technology involves forcing the ink drops through small nozzles by thermal ejection, piezoelectric pressure or oscillation onto the surface of the media. The technology has become a popular way of recording images on various media surfaces (e.g., paper), for a number of reasons, including, low printer noise, capability of high-speed recording and multi-color recording.

### BRIEF DESCRIPTION OF THE DRAWINGS

Features of examples of the present disclosure will become apparent by reference to the following detailed description and drawings.

FIG. 1 illustrates an example of a printing method utilizing the cyan inkjet ink; and

FIG. 2 shows a plot of two-week accelerated storage decel (m/s) results for example and comparative example cyan inkjet inks versus the mean acid number of the respective dispersant(s) in the example and comparative example cyan inkjet inks.

### DETAILED DESCRIPTION

In thermal inkjet printing, the ink composition can affect both the printability of the ink and the print attributes of images that are formed with the ink. As such, ink performance, in terms of both printability and printed image attributes, may be controlled by modifying the components of the ink composition. However, adjusting an ink composition to achieve one attribute of ink performance may result in the compromise of another attribute. For example, including latex particles in an ink can improve the durability of a printed image. However, an increase in the amount of latex particles can also deleteriously affect the printability of the ink by increasing the viscosity, which can lead to clogged nozzles in the printhead, etc. Latex particles can also interact with other ink components, which, in some instances, can result in ink drop velocity deceleration, or “decel.” Decel refers to a decrease in the drop velocity over time (e.g., 6 seconds) of ink droplets fired from an inkjet printhead. In many cases, latex-containing inkjet inks can be subject to decel after the ink has aged for a period of several months. A large decrease in drop velocity (e.g., a decrease in drop velocity of greater than 0.5 m/s) can lead to poor image quality, which can be observed by the color difference between the print samples from continuously firing nozzles and the print samples from non-continuously firing nozzles. In contrast, inks that do not experience decel (i.e., no decrease in drop velocity) or experience an acceptable decel (e.g., a decrease in drop velocity of 0.5 m/s or less) will continue to generate quality printed images.

A cyan pigment dispersion is disclosed herein which includes a dispersant combination that improves the decel performance of inkjet inks that include both the cyan pigment dispersion and latex particles.

### Cyan Pigment Dispersion

The cyan pigment dispersion includes a non-self-dispersed cyan pigment, a first dispersant, with the first dispersant being a styrene-acrylic copolymer having an acid number ranging from about 120 mg KOH/g to about 220 mg KOH/g, a second dispersant, the second dispersant having an acid number less than 100 mg KOH/g, and a balance of water.

As used herein, the term “acid number” refers to the mass of potassium hydroxide (KOH) in milligrams that is used to neutralize one gram of the appropriate dispersant. To determine the acid number, a known amount of a sample may be dissolved in an organic solvent and the solution may be titrated with a solution of potassium hydroxide of a known concentration. Two titration categories can be used, namely potentiometric or colorimetric. The potentiometric method uses a potentiometer to detect the acidic constituents and coverts it to an electronic read out. The output is plotted and analyzed to determine the inflection of the test method. The colorimetric method uses paranaphthol-benzene, which responds to a change in the pH indicator that has been added to the solution. Once the acidic constituents have been neutralized by the KOH, the sample will change from orange to blue-green, indicating the end point. An example of a suitable standard test method is ASTM D3642-15, which is a standard test method for acid number of certain alkali-soluble resins from ASTM (American Society for Testing Materials) International.

The non-self-dispersed cyan pigment may be any copper phthalocyanine pigment that is not capable of self-dispersing. Derivatives of phthalocyanine can be utilized to create copper phthalocyanine pigments. Phthalocyanine is an organic molecule including the general formula C₃₂H₁₈N₈ having the following structure:

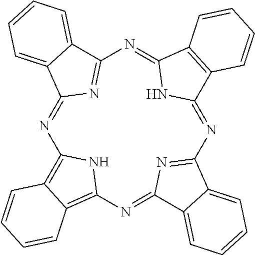

Copper phthalocyanine pigments can be metal complexes in which a copper atom associates with the central nitrogen atoms of the phthalocyanine structure, replacing the two hydrogen atoms of the central NH groups. For example, Pigment Blue 15 has the following structure:

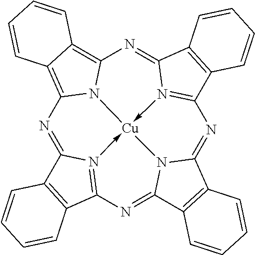

Thus, copper phthalocyanine pigments often do not actually include a phthalocyanine molecule itself, but rather are derived from phthalocyanine. In other examples, copper phthalocyanine pigments can include halogen atoms attached to the aromatic rings of the phthalocyanine structure, such as chlorine and bromine in particular. In some examples, the copper phthalocyanine pigments used in the pigment dispersions and inks described herein can be a phthalocyanine blue pigment or a phthalocyanine green pigment. In specific examples, non-self-dispersed cyan pigment is selected from the group consisting of pigment blue 15, pigment blue 15:1 (PB 15:1), pigment blue 15:3 (PB 15:3), pigment blue 15:4 (PB 15:4), pigment blue 15:6 (PB 15:6), pigment green 7 (PG 7), pigment green 36 (PG 36), and combinations thereof.

The cyan pigment dispersion has a total pigment solids content that ranges from about 10 wt % to about 25 wt % of a total weight of the dispersion.

The first dispersant is a styrene-acrylic copolymer having an acid number ranging from about 120 mg KOH/g to about 220 mg KOH/g. In an example, the acid number of the first dispersant ranges from about 120 mg KOH/g to about 180 mg KOH/g. In another example, the acid number of the first dispersant ranges from about 155 mg KOH/g to about 175 mg KOH/g. In yet another example, the acid number of the first dispersant ranges from about 160 mg KOH/g to about 170 mg KOH/g.

Some commercially available examples of the first dispersant include JONCRYL® 683 (weight average molecular weight (M_{W}) is 8,000, acid number is 165), JONCRYL® 296 (M_{W} is 11,500, acid number is 141), JONCRYL® 695 (M_{W} is 16,500, acid number is 175) and JONCRYL® 671 (M_{W} is 17,250, acid is 214). The weight average molecular weight may be determined using any suitable technique, such as by gel permeation chromatography (GPC).

The second dispersant has an acid number less than 100 mg KOH/g. In another example, the second dispersant has an acid number less than 50 mg KOH/g.

In an example, the second dispersant is selected from the group consisting of a mixed polyethylene glycol/polyethylene glycol ester of styrene maleic acid copolymer, a copolymer of styrene, acrylic, ethylene oxide, and propylene oxide, and a copolymer of ethylene oxide and propylene oxide. Suitable examples of the second dispersant are commercially available, and include DISPERBYK® dispersants from BYK USA, Inc. and TEGO® dispersants from Evonik Industries AG. A specific example of the DISPERBYK® dispersant includes DISPERBYK® 190 (M_{w} is 8,000, acid number is 10). DISPERBYK® 190 is a mixed polyethylene glycol/polyethylene glycol ester of styrene maleic acid copolymer. Specific examples of the TEGO® dispersants include TEGO® 755 W (M_{W} is 6,300, acid number is 15), and TEGO® 760 W (M_{W} is 3,000, acid number is 2). TEGO® 755 W is a slightly anionic glycol/propylene oxide condensate and styrene-acrylic copolymer. TEGO® 760 W is a non-ionic poly(ethylene oxide-propylene oxide) copolymer.

The first and second dispersants may be present in the cyan pigment dispersion in any suitable weight ratio with respect to each other. In an example, the weight ratio of the first dispersant to the second dispersant ranges from about 1:4 to 9:1. In an example, the weight ratio of the first dispersant to the second dispersant is 1:1.

Moreover, the total amount of the two dispersants (i.e., the first and the second dispersants) in the cyan pigment dispersion varies from about 5 wt % to about 100 wt % based on a total weight of the cyan pigment present in the dispersion. As such, in the cyan pigment dispersion, the weight ratio of the cyan pigment to a total of the first dispersant and the second dispersant ranges from about 1:1 to about 20:1. In an example, the weight ratio of the cyan pigment to a total of the first dispersant and the second dispersant is 1:1. In another example, the weight ratio of the cyan pigment to a total of the first dispersant and the second dispersant is 2:1. In another example, the weight ratio of the cyan pigment to a total of the first dispersant and the second dispersant is 4:1.

It is to be understood that in some examples, it may be desirable to select the first dispersant and the second dispersant so that the mean acid number of the dispersants is 150 mg KOH/g or less. In some examples, the mean acid number of the dispersants is also greater than 50 mg KOH/g. The mean acid number is the average of the first and second acid numbers. In the examples disclosed herein, it has been found that too high of a mean acid number and too low of a mean acid number can deleteriously affect the deceleration performance. If it is desirable for the mean acid number of the dispersants to be 140 mg KOH/g, the first dispersant may have an acid number of about 180, and the second dispersant may have an acid number of about 100 mg KOH/g. If it is desirable for the mean acid number of the dispersants to be about 90 mg KOH/g, the first dispersant may have an acid number of about 165 mg KOH/g, and the second dispersant may have an acid number of about 15 mg KOH/g.

In an example, the cyan pigment dispersion excludes an additional dispersant.

In some examples, the pigment dispersion also includes a co-solvent. Examples of suitable co-solvents include organic co-solvents, such as 2-methyl-1,3-propanediol (MPDiol), 2-pyrrolidone (2P), 1,2-propanediol, 1,2-butanediol, ethylene glycol, 2-methyl-2,4-pentanediol, 1,3-butanediol, 1,3-propanediol, 1,4-butanediol, ethylene glycol 2-ethylhexyl ether, dipropylene glycol n-butyl ether, diethylene glycol n-butyl ether, propylene glycol phenyl ether, tripropylene glycol methyl ether, 2,2,4-trimethyl-1,3-pentanediol monoisobutyrate, triethyl citrate, tripropylene glycol n-propyl ether, tripropylene glycol n-butyl ether, tetraethylene glycol dimethyl ether, dipropylene glycol phenyl ether, or combinations thereof. In some instances, other organic co-solvents may be used, including polar solvents such as alcohols, amides, esters, ketones, lactones, and ethers. In some examples, the co-solvent can be an aliphatic alcohol, an aromatic alcohol, diol, glycol ether, polyglycol ether, caprolactam, formamide, acetamide, long chain alcohol, or combinations thereof. As examples, the co-solvent(s) can include 2-methyl-1,3-propanediol (MPDiol), 2-pyrrolidone (2P), 2-ethyl-2-(hydroxymethyl)-1,3-propanediol, glycerol, N-methylpyrrolidone, dimethyl sulfoxide, sulfolane, glycol ethers, alkyldiols, 1,2-hexanediol, ethoxylated glycerols (e.g., LEG-1 (LIPONIC® EG-1)), or combinations thereof. In one specific example, the co-solvent in the pigment dispersion can include 2-methyl-1,3-propanediol, 2-pyrrolidone, or combinations thereof.

The co-solvents can be present in the pigment dispersion in any suitable amount ranging from about 2 wt % to about 30 wt %, from about 5 wt % to about 25 wt %, or from about 10 wt % to about 20 wt % (based on the total weight of the pigment dispersion).

The balance of the cyan pigment dispersion may be water. In an example, the amount of water may range from about 40 wt % to 90 wt % (of the total weight of the pigment dispersion). It is to be understood, however, that the amount of water may be adjusted so that the pigment dispersion has a desirable pigment solids content, and a desirable total solids content.

The preparation of the cyan pigment dispersion involves mixing together the non-self-dispersed cyan pigment and the first and second dispersants. The mixture may be added to a solution of the water and the co-solvent, or the solution of the water and the co-solvent may be added to the mixture. The components may be mixed with a suitable mixer until the dispersion is formed. In an example, mixing is accomplished with a mill and milling beads or another suitable high shear mixer. After mixing, the dispersion may be centrifuged to remove the milling beads. The dispersion may also be diluted so that the total pigment solids ranges from about 10% to about 25% of the total weight of the dispersion.

### Latex Dispersion

Examples of the cyan inkjet ink disclosed herein include latex particles. As used herein, the term “latex” refers to a stable dispersion of polymer particles in an aqueous medium. As such, the polymer (latex) particles may be dispersed in water or water and a suitable co-solvent. This aqueous latex dispersion may be incorporated, with the cyan pigment dispersion disclosed herein, into a suitable liquid vehicle to form examples of the cyan inkjet ink.

In some examples, the latex particles can include a polymerization product of monomers including: a copolymerizable surfactant; an aromatic monomer selected from styrene, an aromatic (meth)acrylate monomer, and an aromatic (meth)acrylamide monomer; and multiple aliphatic (meth)acrylate monomers or multiple aliphatic (meth)acrylamide monomers. The term “(meth)” indicates that the acrylamide, the acrylate, etc., may or may not include the methyl group. In one example, the latex particles can include a polymerization product of a copolymerizable surfactant such as HITENOL™ BC-10, BC-30, KH-05, or KH-10. In another example, the latex particles can include a polymerization product of styrene, methyl methacrylate, butyl acrylate, and methacrylic acid.

In another particular example, the latex particles can include a first heteropolymer phase and a second heteropolymer phase. The first heteropolymer phase is a polymerization product of multiple aliphatic (meth)acrylate monomers or multiple aliphatic (meth)acrylamide monomers. The second heteropolymer phase can be a polymerization product of an aromatic monomer with a cycloaliphatic monomer, wherein the aromatic monomer is an aromatic (meth)acrylate monomer or an aromatic (meth)acrylamide monomer, and wherein the cycloaliphatic monomer is a cycloaliphatic (meth)acrylate monomer or a cycloaliphatic (meth)acrylamide monomer. The second heteropolymer phase can have a higher glass transition temperature than the first heteropolymer phase. The first heteropolymer composition may be considered a soft polymer composition and the second heteropolymers composition may be considered a hard polymer composition.

The two phases can be physically separated in the latex particles, such as in a core-shell configuration, a two-hemisphere configuration, smaller spheres of one phase distributed in a larger sphere of the other phase, interlocking strands of the two phases, and so on.

The first heteropolymer composition can be present in the latex particles in an amount ranging from about 15 wt % to about 70 wt % of a total weight of the polymer particle and the second heteropolymer composition can be present in an amount ranging from about 30 wt % to about 85 wt % of the total weight of the polymer particle. In other examples, the first heteropolymer composition can be present in an amount ranging from about 30 wt % to about 40 wt % of a total weight of the polymer particle and the second heteropolymer composition can be present in an amount ranging from about 60 wt % to about 70 wt % of the total weight of the polymer particle. In one specific example, the first heteropolymer composition can be present in an amount of about 35 wt % of a total weight of the polymer particle and the second heteropolymers composition can be present in an amount of about 65 wt % of the total weight of the polymer particle.

As mentioned herein, the first heteropolymer phase can be polymerized from two or more aliphatic (meth)acrylate ester monomers or two or more aliphatic (meth)acrylamide monomers. The aliphatic (meth)acrylate ester monomers may be linear aliphatic (meth)acrylate ester monomers and/or cycloaliphatic (meth)acrylate ester monomers. Examples of the linear aliphatic (meth)acrylate ester monomers can include ethyl acrylate, ethyl methacrylate, benzyl acrylate, benzyl methacrylate, propyl acrylate, propyl methacrylate, isopropyl acrylate, isopropyl methacrylate, butyl acrylate, butyl methacrylate, isobutyl acrylate, isobutyl methacrylate, hexyl acrylate, hexyl methacrylate, isooctyl acrylate, isooctyl methacrylate, octadecyl acrylate, octadecyl methacrylate, lauryl acrylate, lauryl methacrylate, hydroxyethyl acrylate, hydroxyethyl methacrylate, hydroxyhexyl acrylate, hydroxyhexyl methacrylate, hydroxyoctadecyl acrylate, hydroxyoctadecyl methacrylate, hydroxylauryl methacrylate, hydroxylauryl acrylate, 2-ethylhexyl acrylate, 2-ethylhexyl methacrylate, and combinations thereof. Examples of the cycloaliphatic (meth)acrylate ester monomers can include cyclohexyl acrylate, cyclohexyl methacrylate, methylcyclohexyl acrylate, methylcyclohexyl methacrylate, trimethylcyclohexyl acrylate, trimethylcyclohexyl methacrylate, tert-butylcyclohexyl acrylate, tert-butylcyclohexyl methacrylate, and combinations thereof.

Also as mentioned herein, the second heteropolymer phase can be polymerized from a cycloaliphatic monomer and an aromatic monomer. The cycloaliphatic monomer can be a cycloaliphatic (meth)acrylate monomer or a cycloaliphatic (meth)acrylamide monomer. The aromatic monomer can be an aromatic (meth)acrylate monomer or an aromatic (meth)acrylamide monomer. the cycloaliphatic monomer of the second heteropolymer phase can be cyclohexyl acrylate, cyclohexyl methacrylate, methylcyclohexyl acrylate, methylcyclohexyl methacrylate, trimethylcyclohexyl acrylate, trimethylcyclohexyl methacrylate, tert-butylcyclohexyl a crylate, tert-butylcyclohexyl methacrylate, or a combination thereof. In still further examples, the aromatic monomer of the second heteropolymer phase can be 2-phenoxyethyl methacrylate, 2-phenoxyethyl acrylate, phenyl propyl methacrylate, phenyl propyl acrylate, benzyl methacrylate, benzyl acrylate, phenylethyl methacrylate, phenylethyl acrylate, benzhydryl methacrylate, benzhydryl acrylate, 2-hydroxy-3-phenoxypropyl acrylate, 2-hydroxy-3-phenoxypropyl methacrylate, N-benzyl methacrylamide, N-benzyl acrylamide, N,N-diphenyl methacrylamide, N,N-diphenyl acrylamide, naphthyl methacrylate, naphthyl acrylate, phenyl methacrylate, phenyl acrylate, or a combination thereof.

The latex particles can have a particle size ranging from 20 nm to 500 nm, from 50 nm to 350 nm, or from 150 nm to 270 nm.

In some examples, the latex particles can be prepared by flowing multiple monomer streams into a reactor. An initiator can also be included in the reactor. The initiator may be selected from a persulfate, such as a metal persulfate or an ammonium persulfate. In some examples, the initiator may be selected from a sodium persulfate, ammonium persulfate or potassium persulfate. The preparation process may be performed in water, resulting in the aqueous latex dispersion.

### Cyan Inkjet Ink

The cyan inkjet ink disclosed herein includes a non-self-dispersed cyan pigment, a first dispersant, the first dispersant being a styrene-acrylic copolymer having an acid number ranging from about 120 mg KOH/g to about 180 mg KOH/g, a second dispersant, the second dispersant having an acid number less than 100 mg KOH/g, a co-solvent, a surfactant, latex particles, and a balance of water.

The non-self-dispersed cyan pigment in the ink may be any of the examples disclosed herein. In the ink, the non-self-dispersed cyan pigment is present in an amount ranging from about 1.5 wt % to about 6 wt % based on a total weight of the ink. It is to be understood that this percentage is directed to the amount of pigment solids (i.e., active pigment), and thus when the cyan pigment dispersion is used to make the inkjet ink, this percentage does not account for any of the other components (e.g., dispersants, water, etc.) of the dispersion that may be included.

The first dispersant and the second dispersant may be any of the respective examples disclosed herein.

The total amount of the first and second dispersants present in the ink may depend upon the amount of the non-self-dispersed cyan pigment present in the ink. In an example, the weight ratio of the non-self-dispersed cyan pigment to the total of the first and second dispersants present in the ink ranges from 1:1 to about 20:1, and the weight ratio of the first dispersant to the second dispersant in the ink ranges from about 1:4 to 9:1. It is to be understood that the pigment: total dispersants weight ratio is directed to the total pigment solids and the total amount of first and second dispersants, and thus when the cyan pigment dispersion is used to make the inkjet ink, this percentage does not account for any of the other components (e.g., water, etc.) of the dispersion that may be included. Moreover, when the cyan pigment dispersion is used to make the inkjet ink, it should be noted that the amount of pigment and dispersants present in the cyan inkjet ink will depend upon how much of each of the pigment and dispersants is in the cyan pigment dispersion, and how much of the cyan pigment dispersion is added to form the cyan inkjet ink.

As is discussed further herein with respect to a method of making the inkjet ink, any example of the cyan pigment dispersion disclosed herein may be used to form the inkjet ink. As such, in an example of the ink, the mean acid number of the first dispersant and the second dispersant is 150 mg KOH/g or less. In some examples of the ink, the mean acid number of the dispersants is also greater than 50 mg KOH/g. In a specific example of the cyan inkjet ink, the mean acid number of the first dispersant and the second dispersant is 120 mg KOH/g. In still another example, a mean acid number of the first dispersant and the second dispersant is 100 mg KOH/g.

In the cyan inkjet ink, the latex particles can be present in an amount ranging from about 1 wt % to about 15 wt %, from about 3 wt % to about 12 wt %, or from about 5 wt % to about 10 wt % (based on the total weight of the ink composition). It is to be understood that the ranges set forth herein for the latex particles in the cyan inkjet ink represent the latex solids, and do not account for any liquid (e.g., water, co-solvent, etc.) that may be introduced into the ink vehicle with the latex dispersion.

The liquid vehicle of the cyan inkjet ink includes a co-solvent and water.

The co-solvent(s) in the liquid vehicle for the ink may be any of those set forth herein for the cyan pigment dispersion. It is to be understood that some of the co-solvent(s) in the final ink formulation may be introduced with the cyan pigment dispersion. The co-solvent(s) can be present in the cyan inkjet ink in any suitable amount ranging from about 5 wt % to about 40 wt %, from about 10 wt % to about 35 wt %, from about 15 wt % to about 30 wt %, from about 20 wt % to about 30 wt %, or from about 10 wt % to about 30 wt % (based on the total weight of the ink composition).

The liquid vehicle, and thus the cyan inkjet ink, may also include one or more additives. Examples of suitable additives include a surfactant, an anti-kogation agent, a biocide, or combinations thereof.

The liquid vehicle, and thus the cyan inkjet ink, may also include a surfactant. In one example, the surfactant can include a non-ionic surfactants, fluorosurfactants, phosphate ester surfactants, alkyl polyethylene oxides, alkyl phenyl polyethylene oxides, polyethylene oxide block copolymers, acetylenic polyethylene oxide, polyethylene oxide amines, polyethylene oxide esters, dimethicone copolyols, ethoxylated surfactants, alcohol ethoxylated surfactants, or combinations thereof. Example surfactants can include secondary alcohol ethoxylates (commercially available as TERGITOL® 15-S-7 and TERGITOL® TM-6 from The Dow Chemical Company); fluorinated polymeric surfactant (commercially available as CAPSTONE™ FS-35 available from Chemours); or combinations thereof. If present, the surfactant can be included in the inkjet ink in amounts ranging from about 0.1 wt % to about 5 wt %, from about 1 wt % to about 3 wt %, or from about 0.5 wt % to about 2.5 wt % (based on the total weight of the ink).

An anti-kogation agent may also be included in the cyan inkjet ink. Kogation refers to the deposit of dried ink on a heating element of a thermal inkjet printhead. Anti-kogation agent(s) is/are included in thermal inkjet inks to assist in preventing the buildup of kogation. In some examples, the anti-kogation agent may improve the jettability of the inkjet ink. The anti-kogation agent may be present in the cyan inkjet ink in an amount ranging from about 0.1 wt % to about 1.5 wt %, based on the total weight of the cyan inkjet ink. In an example, the anti-kogation agent is present in the inkjet ink in an amount of about 0.5 wt %, based on the total weight of the inkjet ink.

Examples of suitable anti-kogation agents include oleth-3-phosphate (commercially available as CRODAFOS™ O3A or CRODAFOS™ N-3A) or dextran 500 k. Other suitable examples of the anti-kogation agents include CRODAFOS™ HCE (phosphate-ester from Croda Int.), CRODAFOS® N10 (oleth-10-phosphate from Croda Int.), or Dispersogen® LFH (polymeric dispersing agent with aromatic anchoring groups, acid form, anionic, from Clariant), etc.

The cyan inkjet ink may also include biocide(s). In an example, the total amount of biocide(s) in the cyan inkjet ink ranges from about 0.02 wt % active to about 0.05 wt % active (based on the total weight of the cyan inkjet ink). In another example, the total amount of biocide(s) in the cyan inkjet ink is about 0.044 wt % active (based on the total weight of the cyan inkjet ink). In some instances, the biocide may be present in the pigment dispersion that is mixed with the vehicle. The active amount refers to the amount of active biocide and not all of the components of the biocide composition (e.g., water).

Examples of suitable biocides include the NUOSEPT® (Ashland Inc.), UCARCIDE™ or KORDEK™ (Dow Chemical Co.), PROXEL® (Arch Chemicals) series, ACTICIDE® B20 and ACTICIDE® M20 (Thor Chemicals), and combinations thereof.

The balance of the cyan inkjet ink is water. As mentioned herein, the water in the ink may be contributed by the pigment dispersion, the latex dispersion, and by the liquid vehicle. As such, the amount of water included may vary, depending upon the amounts of the dispersions added to form the inkjet ink. In an example, the water is deionized water. In examples where the inkjet ink is a thermal inkjet ink, the liquid vehicle is an aqueous based vehicle including at least 70% by weight of water. In examples where the inkjet ink is a piezoelectric inkjet ink, the liquid vehicle is a solvent based vehicle including at least 50% by weight of the co-solvent.

An example of a method of making the cyan inkjet ink includes mixing any example of the aqueous latex dispersion disclosed herein and any example of the cyan pigment dispersion disclosed herein in the liquid vehicle to form the cyan inkjet ink. As discussed herein, the liquid vehicle used to make the ink may include the co-solvent and water alone, or in combination with any of the additive(s) set forth herein for the ink.

Any example of the cyan pigment dispersion disclosed herein may be included in the liquid vehicle. The amount of the cyan pigment dispersion that is added will be in any amount suitable to render the pigment solids within the range set forth herein for the ink.

Any example of the aqueous latex dispersion disclosed herein may be included in the liquid vehicle. The amount of the aqueous latex dispersion that is added will be in any amount suitable to render the latex particle solids within the range set forth herein for the ink.

### Printing Method

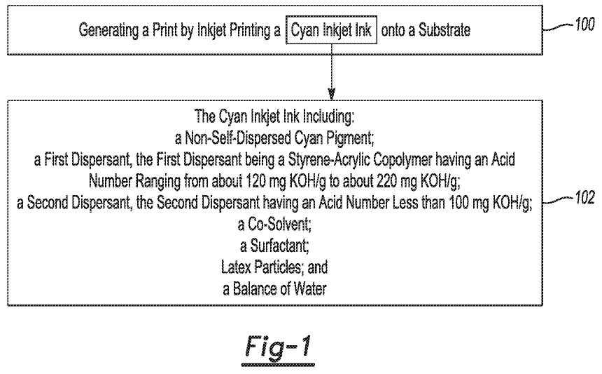

An example of a printing method 100 is shown in FIG. 1. This method 100 uses any example of the cyan inkjet ink disclosed herein, an example of which is shown in box 102 of FIG. 1. As such, an example of the method 100 includes generating a print by inkjet printing a cyan inkjet ink onto a substrate, the cyan inkjet ink including a non-self-dispersed cyan pigment; a first dispersant, the first dispersant being a styrene-acrylic copolymer having an acid number ranging from about 120 mg KOH/g to about 180 mg KOH/g; a second dispersant, the second dispersant having an acid number less than 100 mg KOH/g; a co-solvent; a surfactant; latex particles; and a balance of water.

Any suitable substrate may be used. Examples of a suitable substrate include various paper media or synthetic media. The cyan inkjet ink may be used to generate a print on a paper substrate, such as plain paper, paper including COLOROK® technology (including a calcium chloride additive for pigment crashing), coated paper, or on a synthetic substrate, such as vinyl, polyester, polypropylene, polyethylene terephthalate, or a rigid medium, such as acrylics, aluminum, styrene, polycarbonate, glass, etc.

In an example of the printing method, the printing is accomplished using a thermal inkjet printer. In another example, the components of the inkjet ink could be adjusted for use with a piezoelectric inkjet printer.

### EXAMPLES

### Example 1

Three example cyan pigment dispersions were prepared in accordance with the examples disclosed herein. These formulations included the first and second dispersants disclosed herein. Comparative example cyan pigment dispersions were also prepared. The comparative dispersions had either the first dispersant as the only dispersant, the second dispersant as the only dispersant, or a combination of two example dispersants that would qualify as the first dispersant as it is defined herein. The various dispersants as shown in Table 1, along with their respective acid numbers and weight average molecular weight.

TABLE 1

| | | | Weight |
|---|---|---|---|
| | | | Average |
| Dispersant | | Acid | Molecular |
| Type | Specific Component | Number | Weight |
| First | JONCRYL ® 296 | 141 | 11.500 |
| dispersant | (styrene acrylic, BASF Corp.) | | |
| | JONCRYL ® 683 | 165 | 8.000 |
| | (styrene acrylic, BASF Corp.) | | |
| | JONCRYL ® 671 | 214 | 17.250 |
| | (styrene acrylic, BASF Corp.) | | |
| Second | DISPERBYK ® 190 | 10 | 8.000 |
| dispersant | (a mixed polyethylene glycol/ | | |
| | polyethylene glycol ester of styrene | | |
| | maleic acid copolymer, | | |
| | BYK USA, Inc.) | | |
| | TEGO ® 755W | 15 | 6.300 |
| | (glycol/propylene oxide condensate and | | |
| | styrene-acrylic copolymer, Evonik Ind.) | | |
| | TEGO ® 760W | 2 | 3.000 |
| | (non-ionic poly(ethylene | | |
| | oxide-propylene oxide) | | |
| | copolymer, Evonik Ind.) | | |

The formulations of the example cyan pigment dispersions are presented in Table 2 below. The percentages represent weight percentages of the individual components in each cyan pigment dispersion. Each of the example cyan pigment dispersions had a weight ratio of pigment to total dispersants of 4:1.

TABLE 2

| | | Ex. | Ex. | Ex. |
|---|---|---|---|---|
| | | Disp. 1 | Disp. 2 | Disp. 3 |
| Ingredient | Specific Component | (wt %) | (wt %) | (wt %) |
| Cyan Pigment | Pigment Blue 15:3 | 15 | 15 | 15 |
| First dispersant | JONCRYL ® 683 | 1.875 | 1.875 | 1.875 |
| Second | DISPERBYK ® 190 | 1.875 | — | — |
| dispersant | TEGO ® 755W | — | 1.875 | — |
| | TEGO ® 760W | — | — | 1.875 |
| Co-Solvent | 2-methyl-1,3-propanediol | 12.5 | 12.5 | 12.5 |
| | (MPDiol) | | | |
| Water | Deionized Water | Balance | Balance | Balance |
| pH | | 8.8 | 8.8 | 9.1 |

The formulations of the comparative example cyan pigment dispersions are presented in Table 3 below. The percentages represent weight percentages of the individual components in each cyan pigment dispersion. Each of comparative example cyan pigment dispersions 1-5 and 7 had a weight ratio of pigment to total dispersants of 4:1, and comparative example cyan pigment dispersion 6 had a weight ratio of pigment to total dispersants of 6:1.

TABLE 3

| | | Comp. | Comp. | Comp. | Comp. | Comp. | Comp. | Comp. |
|---|---|---|---|---|---|---|---|---|
| | Specific | Disp. 1 | Disp. 2 | Disp. 3 | Disp. 4 | Disp. 5 | Disp. 6 | Disp. 7 |
| Ingredient | Component | (wt %) | (wt %) | (wt %) | (wt %) | (wt %) | (wt %) | (wt %) |
| Cyan | Pigment Blue | 15 | 15 | 15 | 15 | 15 | 15 | 15 |
| Pigment | 15:3 | | | | | | | |
| First | JONCRYL ® | — | — | — | — | 3.75 | — | — |
| dispersant | 671 | | | | | | | |
| | JONCRYL ® | — | — | — | 3.75 | — | 2.5 | 1.875 |
| | 683 | | | | | | | |
| | JONCRYL ® | — | — | 3.75 | — | — | — | 1.875 |
| | 296 | | | | | | | |
| Second | DISPERBYK ® | 3.75 | — | — | — | — | — | — |
| dispersant | 190 | | | | | | | |
| | TEGO ® | — | 3.75 | — | — | — | — | — |
| | 760W | | | | | | | |
| Co- | 2-methyl-1,3- | 12.5 | 12.5 | 12.5 | 12.5 | 12.5 | 12.5 | 12.5 |
| Solvent | propanediol | | | | | | | |
| | (MPDiol) | | | | | | | |
| Water | Deionized | Bal. | Bal. | Bal. | Bal. | Bal. | Bal. | Bal. |
| | Water | | | | | | | |
| pH | | 6.7 | 7.7 | 8.9 | 9.2 | 9.0 | 9.3 | 9.1 |

These dispersions were tested for stability.

Each example and comparative example dispersion was stored in an accelerated storage (AS) or accelerated shelf life (ASL) environment at a temperature of 60° C. for one week. The particle size for each example and comparative example dispersion was measured before and after the dispersions were stored in the AS environment. The particle size for each example and comparative example dispersion was measured in terms of the volume-weighted mean diameter (Mv) and the D95 (i.e., 95% the population is below this value) using dynamic light scattering with a NANOTRAC® WAVE™ particle size analyzer (available from MICROTRAC™—NIKKISO GROUP™. Then the percent change in particle size was calculated for each example and comparative example dispersion. The particle size for each example and comparative example dispersion before and after one week in the AS environment and the results of the particle size change are shown in Table 4.

TABLE 4

| | | | | | Particle size | Particle size |
|---|---|---|---|---|---|---|
| | | | | | change | change |
| Ex. or | Particle size | Particle size | Particle size | Particle size | after | after |
| Comp. Ex. | before AS | before AS | after 1 wk AS | after 1 wk AS | 1 wk AS | 1 wk AS |
| Dispersion | (Mv, μm) | (D95, μm) | (Mv, μm) | (D95, μm) | (Mv, %) | (D95, %) |
| Ex. Disp. 1 | 0.124 | 0.226 | 0.128 | 0.219 | 3.2 | −3.1 |
| Ex. Disp. 2 | 0.125 | 0.205 | 0.121 | 0.220 | −3.2 | 7.3 |
| Ex. Disp. 3 | 0.125 | 0.211 | 0.117 | 0.206 | −6.4 | −2.4 |
| Comp. | 0.130 | 0.258 | 0.124 | 0.250 | −4.6 | −3.1 |
| Disp. 1 | | | | | | |
| Comp. | 0.113 | 0.202 | 0.116 | 0.198 | 2.7 | −2.0 |
| Disp. 2 | | | | | | |
| Comp. | 0.120 | 0.196 | 0.121 | 0.222 | 0.8 | 13.3 |
| Disp. 3 | | | | | | |
| Comp. | 0.115 | 0.193 | 0.118 | 0.209 | 2.4 | 8.2 |
| Disp. 4 | | | | | | |
| Comp. | 0.121 | 0.199 | 0.117 | 0.196 | −3.4 | −1.6 |
| Disp. 5 | | | | | | |
| Comp. | 0.125 | 0.226 | 0.126 | 0.226 | 0.8 | 0 |
| Disp. 6 | | | | | | |
| Comp. | 0.115 | 0.209 | 0.188 | 0.204 | 63.5 | −2.4 |
| Disp. 7 | | | | | | |

Additionally, each example and comparative example dispersion was put through a T-cycle. During the T-cycle, each example and comparative example dispersion was heated to and maintained at a high temperature of 70° C. for 4 hours, and then each dispersion was cooled to and maintained at a low temperature of −40° C. for 4 hours. This process was repeated for each example and comparative example dispersion for 5 cycles. For each example and comparative example dispersion, the particle size (in terms of My and D95) was measured before and after the T-cycle, and the percent change in particle size was calculated. The particle size for each example and comparative example dispersion before and after the T-cycle and the results of the particle size change calculations are shown below in Table 5.

TABLE 5

| | | | | | Particle size | Particle size |
|---|---|---|---|---|---|---|
| | Particle size | Particle size | | | % change | % change |
| Ex. or | before | before | Particle size | Particle size | after | after |
| Comp. Ex. | T-cycle | T-cycle | after T-cycle | after T-cycle | T-cycle | T-cycle |
| Dispersion | (Mv, μm) | (D95, μm) | (Mv, μm) | (D95, μm) | (Mv, %) | (D95, %) |
| Ex. Disp. 1 | 0.124 | 0.226 | 0.128 | 0.218 | 3.2 | −3.5 |
| Ex. Disp. 2 | 0.125 | 0.205 | 0.125 | 0.213 | 0 | 3.9 |
| Ex. Disp. 3 | 0.125 | 0.211 | 0.122 | 0.201 | −2.4 | −4.7 |
| Comp. | 0.130 | 0.258 | 0.130 | 0.246 | 0 | −4.7 |
| Disp. 1 | | | | | | |
| Comp. | 0.113 | 0.202 | 0.121 | 0.200 | 7.1 | −1.0 |
| Disp. 2 | | | | | | |
| Comp. | 0.120 | 0.196 | 0.120 | 0.203 | 0 | 3.6 |
| Disp. 3 | | | | | | |
| Comp. | 0.115 | 0.193 | 0.119 | 0.220 | 3.7 | 13.8 |
| Disp. 4 | | | | | | |
| Comp. | 0.121 | 0.199 | 0.128 | 0.211 | 6.0 | 6.1 |
| Disp. 5 | | | | | | |
| Comp. | 0.125 | 0.226 | 0.117 | 0.222 | −6.4 | −1.8 |
| Disp. 6 | | | | | | |
| Comp. | 0.115 | 0.209 | 0.113 | 0.199 | −1.7 | −4.8 |
| Disp. 7 | | | | | | |

The results shown in Tables 4 and 5 indicate that the example dispersions are as or more stable than the comparative example dispersions.

### Example 2

Three example cyan inkjet inks were prepared using, respectively, the example cyan pigment dispersions from Example 1. Seven comparative example cyan inkjet inks were prepared using, respectively, the comparative example cyan pigment dispersions from Example 1.

Each of the example and comparative example inks included latex particles. The latex particles were formed with two different streams of monomers. One monomer stream included a solution of soft component monomers (i.e., monomers suitable for forming the first heteropolymer composition disclosed herein), and the other monomer stream included an emulsion of several hard and/or hydrophobic component monomers and an additional monomer (i.e., monomers suitable for forming the second heteropolymer composition disclosed herein).

The latex particles were prepared as follows. Deionized water (58.6 g) was heated to 77° C. with mechanical agitation in a reactor. At 77° C., latex seed (5.0 g at 49% solids; 67 nm particle size) was added to the reactor. Also at 77° C., potassium persulfate (0.2 g) dissolved in water (4% solution) was added. Three streams were added to the reactor: (A) a monomer solution including methyl methacrylate (12.1 g), butyl acrylate (22.4 g), and methacrylic acid (0.54 g); (B) a solution of copolymerizable surfactant (HITENOL® AR-1025) (1.75 g) dissolved in water (5.0 g); and (C) a solution of potassium persulfate (0.2 g) dissolved in water (10.0 g). Streams (A) and (B) were added over 105 minutes. Stream (C) was initiated with streams (A) and (B), but with a targeted feed time of 360 minutes. When streams (A) and (B) were completed, the reaction was held at 77° C. for one hour (stream (C) continued to feed during this time). After the one hour period, a new feed (D) was fed over 195 minutes. Feed (D) included an aqueous emulsion of water (30 g), copolymerizable surfactant (HITENOL® AR-1025) (7.0 g), cyclohexyl methacrylate (45.1 g), cyclohexyl acrylate (6.5 g), phenoxyethyl methacrylate (9.1 g), and methacrylic acid (2.6).

Residual monomer was reduced by adding cyclohexyl acrylate (0.92 g) after increasing the temperature to 85° C. The temperature was held at 85° C. for one hour, followed by the addition of a 5% solution of ascorbic acid (4.2 g) and a 5% solution of tert-butyl hydroperoxide (8.4 g) at 70° C. After cooling to near ambient temperature, the pH was adjusted to 8 with dilute potassium hydroxide; and inkjet suitable aqueous biocides were added.

The resulting polymer particles included a two heteropolymer phases—one of methyl methacrylate, butyl acrylate, and methacrylic acid and the other of cyclohexyl methacrylate, cyclohexyl acrylate, phenoxyethyl methacrylate, and methacrylic acid. The example polymer particles were present in an emulsion (i.e., a latex emulsion), and made up 42.4% solids by total weight of the latex emulsion. The particle size of the example polymer particles was 0.215 μm (particle size determined using Microtrac Nanotrac Wave II), and the viscosity (at 25° C.) of the latex emulsion was less than 50 cps.

The formulation of each of the example cyan inkjet inks is presented in Table 6 below. The formulation of each of the comparative example cyan inkjet inks is presented in Table 7 below. In each of Tables 6 and 7, the percentages represent weight percentages of active pigment, latex, surfactant, and anti-kogation components in the example and comparative inks.

TABLE 6

| | | Ex. ink 1 | Ex. ink 2 | Ex. ink 3 |
|---|---|---|---|---|
| Ingredient | Specific Component | (wt %) | (wt %) | (wt %) |
| Cyan pigment | Ex. Disp. 1 from Example 1 | *2 | — | — |
| dispersion | Ex. Disp. 2 from Example 1 | — | *2 | — |
| | Ex. Disp. 3 from Example 1 | — | — | *2 |
| Latex | As prepared in this example | 10 | 10 | 10 |
| Co-solvents | 1,2-Butanediol | 18 | 18 | 18 |
| | 2-pyrrollidone | 3 | 3 | 3 |
| | DOWANOL ™ TPM | 2 | 2 | 2 |
| | (Tripropylene Glycol Methyl Ether, | | | |
| | The Dow Chemical Co.) | | | |
| Surfactants | TERGITOL ® 15-S-7 | 0.2 | 0.2 | 0.2 |
| | (secondary alcohol ethoxylate, | | | |
| | The Dow Chemical Co.) | | | |
| | CAPSTONE ® FS-35 | 0.4 | 0.4 | 0.4 |
| | (fluorinated polymeric surfactant, Chemours) | | | |
| Anti-kogation | CRODAFOS ® O3A | 0.35 | 0.35 | 0.35 |
| agent | (oleth-3-phosphate, Croda, Inc.) | | | |
| Water | Deionized Water | Balance | Balance | Balance |
| pH | | 8.5 | 8.5 | 8.5 |

*This amount represents the final amount of pigment solids in the ink composition. The total amount of the first and second dispersants was 0.5 wt %.

TABLE 7

| | | Comp. | Comp. | Comp. | Comp. | Comp. | Comp. | Comp. |
|---|---|---|---|---|---|---|---|---|
| | Specific | ink 1 | ink 2 | ink 3 | ink 4 | ink 5 | ink 6 | ink 7 |
| Ingredient | Component | (wt %) | (wt %) | (wt %) | (wt %) | (wt %) | (wt %) | (wt %) |
| Comp. | Comp. Disp. 1* | **2 | — | — | — | — | — | — |
| Dispersion | Comp. Disp. 2* | — | **2 | — | — | — | — | — |
| | Comp. Disp. 3* | — | — | **2 | — | — | — | — |
| | Comp. Disp. 4* | — | — | — | **2 | — | — | — |
| | Comp. Disp. 5* | — | — | — | — | **2 | — | — |
| | Comp. Disp. 6* | — | — | — | — | — | **2 | — |
| | Comp. Disp. 7* | — | — | — | — | — | — | **2 |
| Latex | As prepared in | 10 | 10 | 10 | 10 | 10 | 10 | 10 |
| | this example | | | | | | | |
| Co- | 1,2-Butanediol | 18 | 18 | 18 | 18 | 18 | 18 | 18 |
| solvents | 2-pyrrollidone | 3 | 3 | 3 | 3 | 3 | 3 | 3 |
| | DOWANOL ™ | 2 | 2 | 2 | 2 | 2 | 2 | 2 |
| | TPM | | | | | | | |
| | (Tripropylene | | | | | | | |
| | Glycol Methyl | | | | | | | |
| | Ether, The | | | | | | | |
| | Dow Chemical | | | | | | | |
| | Co.) | | | | | | | |
| Surfactants | TERGITOL ® | 0.2 | 0.2 | 0.2 | 0.2 | 0.2 | 0.2 | 0.2 |
| | 15-S-7 | | | | | | | |
| | (secondary | | | | | | | |
| | alcohol | | | | | | | |
| | ethoxylate, | | | | | | | |
| | The Dow | | | | | | | |
| | Chemical Co.) | | | | | | | |
| | CAPSTONE ® | 0.4 | 0.4 | 0.4 | 0.4 | 0.4 | 0.4 | 0.4 |
| | FS-35 | | | | | | | |
| | (fluorinated | | | | | | | |
| | polymeric | | | | | | | |
| | surfactant, | | | | | | | |
| | Chemours) | | | | | | | |
| Anti- | CRODAFOS ® | 0.35 | 0.35 | 0.35 | 0.35 | 0.35 | 0.35 | 0.35 |
| kogation | O3A | | | | | | | |
| agent | (oleth-3- | | | | | | | |
| | phosphate, | | | | | | | |
| | Croda, Inc.) | | | | | | | |
| Water | Deionized | Balance | Balance | Balance | Balance | Balance | Balance | Balance |
| | Water | | | | | | | |
| pH | | 8.5 | 8.5 | 8.5 | 8.5 | 8.5 | 8.5 | 8.5 |

*Comparative Dispersion from Example 1

**This amount represents the final amount of pigment solids in the comparative example ink composition. Each of comparative example cyan inks 1-5 and 7 had a weight ratio of pigment to total dispersants of 4:1, and comparative example cyan ink 6 had a weight ratio of pigment to total dispersants of 6:1.

The example and comparative inks were tested for stability using the accelerated storage and T-cycle tests described in Example 1. The particle size for each example and comparative example ink before and after one week in the AS environment and the results of the particle size change calculations are shown in Table 8. The particle size for each example and comparative example dispersion before and after the T-cycle and the results of the particle size change calculations are shown below in Table 8.

TABLE 8

| | | | | | Particle size | Particle size |
|---|---|---|---|---|---|---|
| | | | | | change | change |
| Ex. or | Particle size | Particle size | Particle size | Particle size | after | after |
| Comp. Ex. | before AS | before AS | after 1 wk AS | after 1 wk AS | 1 wk AS | 1 wk AS |
| Ink | (Mv, μm) | (D95, μm) | (Mv, μm) | (Mv, μm) | (Mv, %) | (D95, %) |
| Ex. ink 1 | 0.175 | 0.307 | 0.171 | 0.308 | −1.8 | 0.3 |
| Ex. ink 2 | 0.172 | 0.287 | 0.181 | 0.306 | 4.9 | 6.7 |
| Ex. ink 3 | 0.176 | 0.294 | 0.174 | 0.274 | −1.2 | −6.9 |
| Comp. ink 1 | 0.172 | 0.286 | 0.168 | 0.302 | −2.4 | 5.7 |
| Comp. ink 2 | 0.173 | 0.290 | 0.174 | 0.287 | 0.5 | −0.8 |
| Comp. ink 3 | 0.169 | 0.285 | 0.173 | 0.302 | 2.0 | 5.8 |
| Comp. ink 4 | 0.184 | 0.302 | 0.171 | 0.295 | −7.3 | −2.4 |
| Comp. ink 5 | 0.172 | 0.287 | 0.164 | 0.289 | −4.3 | 0.8 |
| Comp. ink 6 | 0.173 | 0.294 | 0.172 | 0.299 | −0.7 | 1.6 |
| Comp. ink 7 | 0.166 | 0.272 | 0.171 | 0.293 | 3.3 | 7.7 |

TABLE 9

| | | | | | Particle size | Particle size |
|---|---|---|---|---|---|---|
| | Particle size | Particle size | | | % change | % change |
| Ex. or | before | before | Particle size | Particle size | after | after |
| Comp. Ex. | T-cycle | T-cycle | after T-cycle | after T-cycle | T-cycle | T-cycle |
| Ink | (Mv, μm) | (D95, μm) | (Mv, μm) | (D95, μm) | (Mv, %) | (D95, %) |
| Ex. ink 1 | 0.175 | 0.307 | 0.182 | 0.309 | 4.0 | 0.7 |
| Ex. ink 2 | 0.172 | 0.287 | 0.177 | 0.307 | 2.7 | 7.0 |
| Ex. ink 3 | 0.176 | 0.294 | 0.174 | .0313 | −1.1 | 6.5 |
| Comp. ink 1 | 0.172 | 0.286 | 0.173 | 0.315 | 0.6 | 10.3 |
| Comp. ink 2 | 0.173 | 0.290 | 0.178 | 0.305 | 2.8 | 5.2 |
| Comp. ink 3 | 0.169 | 0.285 | 0.169 | 0.288 | −0.4 | 1.0 |
| Comp. ink 4 | 0.184 | 0.302 | 0.175 | 0.313 | −5.1 | 3.6 |
| Comp. ink 5 | 0.172 | 0.287 | 0.172 | 0.307 | 0.3 | 7.2 |
| Comp. ink 6 | 0.173 | 0.294 | 0.178 | 0.312 | 2.7 | 6.2 |
| Comp. ink 7 | 0.166 | 0.272 | 0.175 | 0.319 | 5.6 | 17.4 |

The results shown in Tables 8 and 9 indicate that the example inks are as or more stable than the comparative example inks.

The viscosity of each example and comparative example ink was measured before and after accelerated storage testing and T-cycle testing. For viscosity, the example and comparative inks were stored in an accelerated storage environment of 60° C. for two weeks. The T-cycle test was performed as described herein in Example 1. The viscosity results before and after accelerated storage testing and T-cycle testing are shown in Table 10.

TABLE 10

| | | | % change | | % change |
|---|---|---|---|---|---|
| | Viscosity | | in | | in |
| Ex. or | before | Viscosity | Viscosity | Viscosity | Viscosity |
| Comp. Ex. | AS or | after | after | after | after |
| Ink | T-cycle | T-cycle | T-cycle | 2 wk AS | 2 wk AS |
| Ex. ink 1 | 4.0 | 4.0 | 0 | 3.9 | −2.5 |
| Ex. ink 2 | 4.0 | 4.0 | 0 | 3.8 | −5.0 |
| Ex. ink 3 | 4.0 | 4.0 | 0 | 3.9 | −2.5 |
| Comp. ink | 4.0 | 4.0 | 0 | 3.9 | −2.5 |
| 1 | | | | | |
| Comp. ink | 4.2 | 4.1 | −2.4 | 4.0 | −4.8 |
| 2 | | | | | |
| Comp. ink | 3.9 | 4.0 | 2.6 | 3.9 | 0 |
| 3 | | | | | |
| Comp. ink | 4.1 | 3.9 | −4.9 | 3.9 | −4.9 |
| 4 | | | | | |
| Comp. ink | 4.2 | 4.1 | −2.4 | 3.9 | −7.1 |
| 5 | | | | | |
| Comp. ink | 3.9 | 3.9 | 0 | 3.8 | −2.6 |
| 6 | | | | | |
| Comp. ink | 4.0 | 4.1 | 2.5 | 3.9 | −2.5 |
| 7 | | | | | |

The results shown in Table 10 indicate that the example inks are very stable in terms of viscosity, and are as or more stable in terms of viscosity than the comparative example inks.

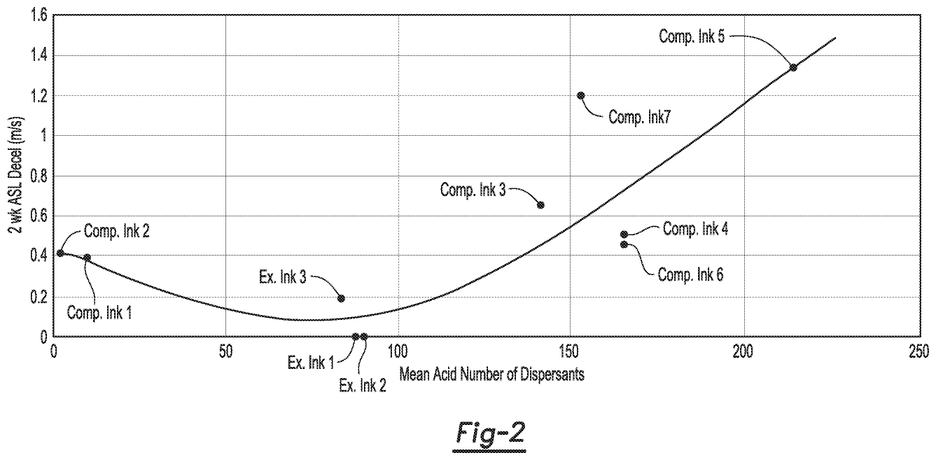

The example and comparative inks were also tested for decel performance. In order to determine decel performance, each of the example and comparative inks were filled into a thermal inkjet print head and the drop velocity vs. firing time over 6 seconds was collected. The example and comparative inks were tested as initially prepared and also after aging for 2 weeks using the accelerated storage test conditions described for the velocity test. The loss in velocity is shown in Table 11 below and in FIG. 2.

TABLE 11

| Ex. Ink or | | Decel |
|---|---|---|
| Comp. Ex. | | (i.e., Loss in |
| Ink | Aging | Velocity) (m/s) |
| Ex. ink 1 | Initial | 0 |
| | 2 Week AS | 0 |
| Ex. ink 2 | Initial | 0 |
| | 2 Week AS | 0 |
| Ex. ink 3 | Initial | 0 |
| | 2 Week AS | 0.19 |
| Comp. ink 1 | Initial | 0 |
| | 2 Week AS | 0.39 |
| Comp. ink 2 | Initial | 0 |
| | 2 Week AS | 0.41 |
| Comp. ink 3 | Initial | 0 |
| | 2 Week AS | 0.65 |
| Comp. ink 4 | Initial | 0 |
| | 2 Week AS | 0.50 |
| Comp. ink 5 | Initial | 0 |
| | 2 Week AS | 1.33 |
| Comp. ink 6 | Initial | 0 |
| | 2 Week AS | 0.45 |
| Comp. ink 7 | Initial | 0 |
| | 2 Week AS | 1.20 |

As shown in Table 11 and FIG. 2, each of the comparative inks showed greater amounts of decel after 2 weeks ASL than each of the example inks. The comparative inks did not contain the first and second dispersants having a mean acid number ranging from about 50 mg KOH/g to about 100 mg KOH/g. In contrast, example inks 1-3 had better decel performance. The decel results suggest that adjusting the combination of first and second dispersant based on their mean acid number tends to improve the decel performance. The decel results also indicate that the molecular weight of the first and/or second dispersants did not correlate with the decel performance.

It is to be understood that the ranges provided herein include the stated range and any value or sub-range within the stated range, as if the value(s) or sub-range(s) within the stated range were explicitly recited. For example, a range from about 0.5 wt % to about 2.5 wt % should be interpreted to include not only the explicitly recited limits of about 0.5 wt % to about 2.5 wt %, but also to include individual values, such as 0.75 wt %, 1.25 wt %, etc., and sub-ranges, such as from about 0.55 wt % to about 2 wt %, from about 1.5 wt % to about 1.7 wt %, etc.

Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A cyan pigment dispersion, comprising:
a non-self-dispersed cyan pigment;
a first dispersant, the first dispersant being a styrene-acrylic copolymer having an acid number ranging from about 120 mg KOH/g to about 220 mg KOH/g;
a second dispersant, the second dispersant having an acid number less than 100 mg KOH/g; and
a balance of water.

2. The cyan pigment dispersion as defined in claim 1 wherein the second dispersant is selected from the group consisting of a mixed polyethylene glycol/polyethylene glycol ester of styrene maleic acid copolymer, a copolymer of styrene, acrylic, ethylene oxide, and propylene oxide, and a copolymer of ethylene oxide and propylene oxide.

3. The cyan pigment dispersion as defined in claim 1 wherein a mean acid number of the first dispersant and the second dispersant is 150 mg KOH/g or less.

4. The cyan pigment dispersion as defined in claim 3 wherein the cyan pigment is selected from the group consisting of pigment blue 15:1, pigment blue 15:3, pigment blue 15:4, pigment blue 15:6, pigment green 7, pigment green 36, and combinations thereof.

5. The cyan pigment dispersion as defined in claim 1 wherein a weight ratio of the first dispersant to the second dispersant ranges from about 1:4 to 9:1.

6. The cyan pigment dispersion as defined in claim 1, further comprising a co-solvent.

7. The cyan pigment dispersion as defined in claim 1 wherein a weight ratio of the cyan pigment to a total of the first dispersant and the second dispersant ranges from about 1:1 to about 20:1.

8. The cyan pigment dispersion as defined in claim 1 wherein a total pigment solids content of the dispersion ranges from about 10 wt % to about 25 wt % of a total weight of the dispersion.

9. The cyan pigment dispersion as defined in claim 1 wherein the dispersion excludes an additional dispersant.

10. A cyan inkjet ink, comprising:
a non-self-dispersed cyan pigment;
a first dispersant, the first dispersant being a styrene-acrylic copolymer having an acid number ranging from about 120 mg KOH/g to about 220 mg KOH/g;
a second dispersant, the second dispersant having an acid number less than 100 mg KOH/g;
a co-solvent;
a surfactant;
latex particles; and
a balance of water.

11. The cyan inkjet ink as defined in claim 10 wherein the second dispersant is selected from the group consisting of a mixed polyethylene glycol/polyethylene glycol ester of styrene maleic acid copolymer, a copolymer of styrene, acrylic, ethylene oxide, and propylene oxide, and a copolymer of ethylene oxide and propylene oxide.

12. The cyan inkjet ink as defined in claim 10 wherein a weight ratio of the cyan pigment to a total of the first dispersant and the second dispersant ranges from about 1:1 to about 20:1.

13. The cyan inkjet ink as defined in claim 10 wherein a mean acid number of the first dispersant and the second dispersant is 150 mg KOH/g or less.

14. A printing method, comprising:
generating a print by inkjet printing a cyan inkjet ink onto a substrate, the cyan inkjet ink including:
a non-self-dispersed cyan pigment;
a first dispersant, the first dispersant being a styrene-acrylic copolymer having an acid number ranging from about 120 mg KOH/g to about 220 mg KOH/g;
a second dispersant, the second dispersant having an acid number less than 100 mg KOH/g;
a co-solvent;
a surfactant;
latex particles; and
a balance of water.

15. The method as defined in claim 14 wherein the printing is accomplished using a thermal inkjet printer.
